(19) United States
(12) Patent Application Publication
(10) Pub. No.: US 2009/0216577 A1
(43) Pub. Date: Aug. 27, 2009

(54) User-generated Review System

(76) Inventor: Todd F. Killebrew, Laurel, MD (US)

Correspondence Address: GREENBERG & LIEBERMAN, LLC, 2141 WISCONSIN AVE, N.W., SUITE C-2, WASHINGTON, DC, 20007, US

(21) Appl. No.: 12/035,788

(22) Filed: Feb. 22, 2008

(51) Int. Cl. G06Q 99/00

(52) U.S. Cl. 705/7; 705/1

(57) ABSTRACT

A system that combines user-generated reviews and user-generated video to create a review website covering an ever-changing list of topics. People located in different cities and colleges throughout the world create videos to both educate and entertain. This allows users to input their positive recommendations of different subjects into the system and offers users the ability to make decisions of what they buy, where they travel, where they go, what they do, and any possible decision that they could ask friends, co-workers, etc.

### FIELD OF THE INVENTION

The present invention is a system that combines user-generated reviews and user-generated video to create a review website covering an ever-changing list of topics. The present invention is comprised of numerous elements relating to user created input and video. Users create/input additional listings that can constantly expand as users add their comments to previous posted listings, and can also add new listings in whatever category and geographic area they desire. The system is not just about matching buyers and sellers, but more about matching users and the information that they seek through the recommendations of other online “friends” and their recommendations. Topics can range from any subject as long as that subject can be recommended to someone else. Users can request what categories to add and upon approval, can be populated within the system under a particular category for other users to also comment about. By using selected people as video hosts of each city or college, the system further enhances the overall experience by giving users someone to explain the site to them, provide them additional insight into the subjects they want to know about, and providing an entertaining format to deliver this user generated video to the user community.

### BACKGROUND OF INVENTION

Many websites utilize video. There are a number of video sharing websites that allow users to create and share this content with other users. One problem with these websites is that none of them use user-generated video to highlight a variety of subjects that users recommend. There is a need in the marketplace for video to be created by everyday people in a particular geographic location or college to provide a more in-depth look into businesses, college life, travel, products, and entertainment. Professional video staff would not create this video, but people whose role would be to highlight the most popular reviews based on what people recommend while providing both educational and entertainment value about that subject.

Websites such as “Cityseach” offers video that spotlights a business. The video is shot by a professional staff and allows the business owner or their representative to pitch a commercial about themselves to the user, showing them at their respective place of business. For example, if the site spotlighted a restaurant, this allows the user to see firsthand what exactly they might experience if they visited. This video, while very informative, is not produced in the same format as a television host would do on a program on television. Instead of a one-way communication between the business owner and the user, a “host” of a television program would visit the business, sit down and hold a conversation with the owner and speak back and forth about how this particular restaurant was special and how it set its self apart from others. This television host would both provide education about this restaurant and what it offers as well as present this information in a lively, entertaining way. “Citysearch”, unlike the present invention can't do this.

Another problem with video or recommendation/review websites is that business owners don't have the ability to create their own user-generated video. The videos primary purpose would be not just to make a commercial about their business, but actually provide education. There is a need in the marketplace to allow business owners to create their own video programming about the products and services that they offer. This video allows a business to create video workshops and informational tips and provides them a platform to reach out to prospective customers by providing their own personal touch.

For example, if a plumber wanted to create a short video explaining a simple repair job for users, this tip along with his personality could make a prospective customer more inclined to call and ask for more information or a quote. By allowing the business to provide a “personal touch” to the video that they produce, it gives the user more reason why they should use their respective service over another. “Citysearch”, while allowing video to be created, unlike the present invention does not do this. It does not provide the business owner the ability, through video, to educate and inform about what they can provide and the quality that they put into their work.

The third problem with video or recommendation/review websites is that they do not present video advertisements in a way that encourages users to view their video. There is a need to group relevant video that the advertisers want to show with the topic of interest that a user selects with a particular website. This would allow a business to display their ad based on the exact subject along with city, state, or college/university that the advertiser wants to target. For example if a user selects “lawyer” in a particular city, grouped next to the results of that search would be relevant video based lawyers that offer their services in the area. There could be both national and local lawyer produced videos. Grouping relevant content with normal search results could allow a user to obtain more information that would lead to a decision.

Another problem with review/recommendation websites is they do not present listings that are exclusively recommended by users. For example, when conducting a search on a website like “Yelp” on “nightclubs” in a particular city, could result in over a hundred nightclubs. Some of these clubs might have been rated, or none of them. There is a need in the marketplace to allow only listings to be displayed that first have been recommended by someone. This reduces the amount of time to find a “good” recommendation without having to search through many listings that could offer no value. By following the process above, the website is nothing more than a “hardcopy” Yellow Pages. It still provides business listings but no further information of value to the user. A different approach would be if no one has recommended listings based on a particular category, then that search result would remain empty until a user recommends something that he/she found to be good. “Yelp”, unlike the present invention, doesn't provide this functionality.

Another problem with video and review/recommendation websites is they do not let the users determine the websites direction. There is a need in the marketplace for users to determine what new sections a website might add based on the popularity of the subject. For example, if users could vote on the next major subject/category, and the results of that voting would determine what was added next or changed, that website would be driven by what the users want, not what the owners of the website want. The website would truly by built for the people, by the people.

The last problem with review/recommendation websites is they focus primarily on businesses. There is a need in the marketplace for a website to allow users to recommend any subject that is good, not just a business. Maybe someone would like to recommend their favorite song, favorite movie, who they think is the best professor on campus, who they think is the best fraternity or sorority, what is the best organization to join on campus, what is the best travel spot for the mature crowd, the best travel spot for the college crowd and any other number of subjects. These listings are still recommendations, but they do not fall under the category of something that has a store-front, or a place that sells something. By allowing users to be able to recommend any subject and group it wants into a category that allows people to search, this provides another platform for people to help other people based on what they found to be a positive experience.

### SUMMARY OF THE INVENTION

The present invention solves the problems in the marketplace with both video and recommendation/review websites. The present invention is a system that combines user-generated reviews and user-generated video to create a review website covering an ever-changing list of topics. People located in different cities and colleges throughout the world create videos to both educate and entertain. The system allows for the input, ranking and presentation of information. Default main topics of interest and categories are created to guide users to understand where further information can be inputted or created. The main video host also helps guide the user in understanding how to get the most out of the site and how to use it.

The present invention essentially permits user-generated reviews to be collected on a Web site. These user-generated reviews are recorded as postings of individual comments. In addition, the present invention calculates the most popular user-generated reviews by factoring in the score of each criteria of which the listing was graded. The preferred embodiment envisions a 1-5 scale, although other grading scale scores may be used. In addition to the scoring aspect, the system of the present invention also takes into account the number of users who tried the particular listing and also liked it as well as the total number of reviews. However, these users will be those who had not yet experienced the listing before. The present invention also provides video segments that are produced by the actual Web site for the best of the user-generated reviews. These video segments include videos produced by employees, reporters or someone else affiliated with the Web site.

### 1. User-Generated Video Based on User Recommendations

The present invention allows for creation of video hosts. The video hosts operate in the same manner as traditional television hosts. The system utilizes “everyday” people (selected by the select owners or their representatives) in order to guide users to understand the website and highlight what good things that users are recommending. Their job is to highlight, through the use of user-generated video, which products, services, travel, etc are being created and rated by users on the site. Each city/college created by users can have a video host of that city. The main video host of the site encourages users to submit their videos to be selected to be a host for their respective city/college. There can be multiple hosts of each city/college as determined by the owners of the system. Each host lends their personality to the content they create by engaging business owners as well as the general public to both educate users and entertain them about the listings that they recommend.

In addition to highlighting the user-generated content that users add to the site, each host can also create their own unique video programming to enhance the users experience in that particular city/college. Each topic of interest: services, travel, products, college life, etc can have a video host that creates video programming based on their geographic area. This enhances the understanding of what other people are recommending and what each host can create on their own to educate and entertain the user. Programming segments such as “The Top Spot”, “Up and Coming”, and “What's Hot In” are created to spotlight different listings. “The Top Spot” which showcases the top rated listings submitted by users, allows users of the web site to get more information about these listings. The host will visit the business, source of the listing or talk about the subject that has received the most positive feedback and lend their personality to providing both education and entertainment about the subject. These video hosts will have the capability to upload content through a web interface to allow them to add programming on a regular basis. This creates each host's own “channel” and will allow users to subscribe to this video programming in order to receive new episodes as they are created. As the site matures, these hosts can be paid for their services by sharing a percentage of the advertising revenue created from their unique programming in each city/college.

### 2. Business Owner Ability to Create Video

The video feature allows a business owner to further promote their business by giving helpful tips in their profession to prospective users via video that they create. This free advice/tips video feature has a number of benefits. One, it allows the business owner to get the word out on the service that they offer by giving helpful information that a user could use. Two, a user benefits by watching this informational video and gets more familiar with a particular industry. Three, by watching these videos, businesses get to become more “personal” to the user and the user can “feel” the sincerity, and overall feeling that they might get from the person on the video. This is a tremendous marketing tool that a small business can master to obtain more customers and increased word of mouth.

### 3. Proper Placement of Video Advertisement

Through different pages on the website, the system allows for advertisers to showcase their businesses and able to reach, through the use of video, a large audience. This video advertisement can be shown in every state or in just one state, city or college depending on the needs of the advertiser. These national and local spotlight videos are placed near the search results/listings. This will allow a user to obtain the listings, while at the same time view relevant video based on the subject, geographic area, or college. This will give each business or entity an opportunity to showcase new product releases, upcoming movie premieres, or new services being offered specifically to the audience they are targeting.

### 4. Only Relevant Listings

The information system starts with only a default set of main topics of interest and main categories grouped by a default list of all states and select cities. The purpose of this is so the user creates the majority of cities, not the administrators of the website. This will also encourage users to submit “their” city/college to continue to grow the website and create a sense of ownership. The goal is for the users to feel as they created the site, not by the owners of the present invention. There will be no listings available for users when the system is first created. All business listings are stored in the backend database. If a user wants to add a business listing they can search the backend database for business listings that they want to recommend. Once they find the business listing they are looking for they can “add” that listing to the “active” portion of the site so other users can now see this listing.

### 5. Users Determination of Website

The present invention will feature a section of the site called “To Be Determined”. This tab allows for users to submit what subjects they would like to be shown on the site. Maybe there is a subject that isn't covered, or maybe a subject needs to be removed from an existing topic of interest and should stand on its own. Users can vote for what they think should be shown on the site and once a pre-defined period is over, the main video host will announce the launching of this new topic of interest. This topic, like all the others, will be shared with all the cities.

### 6. Limitless Number of Subjects

By utilizing the same feature to add local business, users can also add non-business categories/listings based on whatever they would like to recommend. These subjects that users would like to recommend are not found in any back-end database, but are entered by the user and reviewed for relevancy by the system owners. If it is determined that the user community could benefit from the introduction of a new subject, the website system owners will create this new category on the website for other users to also recommend their opinion. Once a new category is created, other users can add listings. The system encourages all users to recommend “good” businesses, services, products, entertainment choices, and other subjects of interest.

An additional embodiment of the present invention relates to allowing the user to query the database of a particular category in order to find “like-minded” users that also might be using the same category. This embodiment operates in much the same way as the additional aspects of the present invention described above. For example, a user might be a married, mother of five kids, who is on a strict budget. By clicking on All-American Restaurant, a user will be able to see all of the restaurants in a particular location and see this list in the order of popularity. Although this is extremely helpful, it would also be useful for this user to know what All-American restaurants in a particular location where visited by people “just like her.”

### BRIEF DESCRIPTION OF THE DRAWINGS

FIG. 1 is a flow chart depicting the preferred embodiment of the process of the present invention relating to a scenario when a city/college is not listed.

FIG. 2 is a flow chart depicting the preferred embodiment of the process of the present invention relating to a scenario when a city/college is listed.

### DETAILED DESCRIPTION OF THE PREFERRED EMBODIMENT

I. Overview

A system that combines user-generated reviews and user-generated video to create a review website covering an ever-changing list of topics. People located in different cities and colleges throughout the world create videos to both educate and entertain. The system allows for the input, ranking and presentation of information. Default main topics of interest and categories are created to guide users to understand where further information can be inputted or created. The main video host also helps guide the user in understanding how to get the most out of the site and how to use it.

The present invention essentially permits user-generated reviews to be collected on a Web site. These user-generated reviews are recorded as postings of individual comments. In addition, the present invention calculates the most popular user-generated reviews by factoring in the score of each criteria of which the listing was graded. The preferred embodiment envisions a 1-5 scale, although other grading scale scores may be used. In addition to the scoring aspect, the system of the present invention also takes into account the number of users who tried the particular listing and also liked it. However, these users will be those who had not yet experienced the listing before. The present invention also provides video segments that are produced by the actual Web site for the best of the user-generated reviews. These video segments include videos produced by employees, reporters or someone else affiliated with the Web site.

There will be no default listings available to users. All listings that are available to users are submitted to the system first by a user. The present invention is designed to simulate the actual word of mouth that takes place between friends. When friends normally ask their friends for recommendations they are looking for “good” recommendations, and the present invention's purpose is to provide “good” recommendations of what people know to this online community. Instead of focusing on “bad” recommendations or recommendations that have disappointed others, the content of the system is driven to provide “what's good” so that users can quickly narrow down their “recommended” choices to choose the best option.

By providing good recommendations, the system, with the help of the video hosts, gives the user the best “good” recommendations. This system is designed to give a detailed ranking based on meaningful ranked criteria and automatically list these rankings in order from the highest rated to the lowest rated. In addition, the present invention displays user-generated reviews for listings that are average or positively ranked. By taking into account the number of people that have rated a particular listing combined with the rankings of those users, the highest rated listing will be shown first with its “Power Ranking.” Each subsequent listing will appear in the order of their “Power Ranking.” The top listing receives the designation of “The #1 Spot”. The “Power Rankings” are designed so that no one person can bring a listing to “The #1 Spot”, since the total number of people that recommended that listing weighs into the placement on the page. A listing can be anything that a user would like to recommend that is good. The listings on this site are not limited to business listings, such as those you find in the yellow pages or other local review website. Anything on any subject that someone wants to recommend can be added to the system. All the listings are held within a main topic of interest with a breakout of categories.

Users receive credit for submission of listings. A user looking at a listing can see the user that recommended it and what city they are from. There is also a feature to be able to send communication to that user if you had questions about that users listing. Just like the “offline” world when a friend tells a friend about a recommendation, the friend can also ask the friend more details about what they have recommended. This enables the person to make a decision whether or not they will follow their friend's recommendation. Users can also click the username that submitted the listing and view the “title” and profile of that user. By looking at the title of each user, a person can tell how much positive impact they have made to overall system content. By allowing users to see other users “title”, a person can see if another individual has contributed listings that have been both helpful to other users and have been highly rated. This also gives the user a reason to submit more listings in order to get a better title and more recognition of their contributions to the building of the system. The factors used to determine the users “title”:
a) Number of Listings added to the present invention
b) Total number of listings that received a 5
c) Number of users that said a particular listing (this user submitted) was useful
d) Total number of listings that received a 4
e) Listings that currently are in the #1 Spot
f) Number of cities they add (website will note who adds cities)
g) Number of new categories they create

The present invention also focuses on both small and big businesses. There are a number of established companies that can pay enormous amounts of money to get visibility to their business. By providing 30-second commercials, and free video workshops, the present invention can increase the awareness and visibility of a small business owner to the masses in a more personal way than just an standard video advertisement in a phone book or local business review website.

There are benefits to advertisers who list their businesses on the site. Advertisers can advertise by topic, category, or geographic area or any combination of the three. This provides for maximum flexibility in allocated advertising dollars. Advertising listings can be placed on relevant pages based on a fixed-fee amount or a “per-click” basis. Users can do searches under different topics and are presented relevant advertising (both video and text) based on the keywords that where used. These keywords match category names and geographic areas of which advertisers will pay to list underneath.

II. Introduction of Elements

1. User Created Listings

All listings are created by user input. For example, some web directories and local review websites when conducting a search of a particular category will list a number of results. If someone searched for an “attorney”, the site could list hundreds of attorney's in that user's city and/or state. The website would then ask the users to be the first to rate the business that were returned as a result of the query. The difference with the present invention is if a similar search was done on the same “attorney” category in that city, and if there were no attorney's added by users in the particular geographic location, the system would inform the user that no listings could be found (although they really do exist, just not on this website) and the user could be the first to create a listing of a particular attorney. The system would allow the user to input an attorney that they feel is “good”. The user would also get “credit” for increasing the listings of the site and obtain a higher status (their title).

A user created listing can be under any topic of interest or category. A listing can be on any subject as long as it fits under a particular topic or category. The system is not limited to businesses to add as listings. The user inputs the listing depending on the topic of interest and category. For example, if a user was under the “Services” topic of interest, they could input their recommendation of a good car repair shop. This listing would be submitted under the appropriate topic, category and geographic area.

Since the system only has a small number of default categories, the user can also submit categories for inclusion. The system only creates a small number of default cities, allowing the user to also create additional cities in the system if a user feels that their city is not represented. By allowing users to create the cities, categories, and listings, the system is able to capture the true desires of the user who wants to create a place that other “online” friends can benefit from their positive experiences. If a listing happens to be a business, users are only able to submit a business by searching the backend database for the correct business name and address. For both submission of a new business listing or basic listing, an administration review takes place, and upon approval, the listing is updated in the system. Once a listing has been officially “added”, subsequent users can search and find these new listings. Business listings in the backend database remain there until a user “adds” them to the presentation piece of the system so all users can view and search on. Any additional information concerning the business listing is added if that particular business owner or entity would like an enhanced listing. Categories can also be added in the same manner as listings, and upon approval by the administrative review, sub-categories can also be created. By allowing users to create the categories and sub-categories, the system is built according to the needs of the user community.

There are a number of attributes that further enhance the user created listings:

A. Geography Attributes

A user created listing can have a geographic attribute. Main topics of interest and listings can be grouped by city and state. Since the system is built based on city and state, it is easier for the user to decide which state and city (if listed) satisfies their need. The search feature available in the site also allows the user to search by keyword within a particular city and state.

B. Topics of Interest

Each user created listing is held within a topic of interest. The topics of interest are the main sections of the system that are used to group the subject matter by city and state. Whenever a new city is created, the default topics of interest are created. The default main topics of interest are: services, products, entertainment, college life, and travel. New topics of interest can be created through the “TBD” tab. Within this TBD section, users can vote to determine what new topic of interest will be created on the site.

C. Main Category

Each user created listing is created within a main category. By default, there are a few main categories that are created for every city. These main categories are used to guide the user to locate the information they are looking for, or to the place that they can add information according to a category within the system. The main category is used to give the high-level topic of which sub categories can be added to “go deeper” into the category. Examples of a main category would be lawyer, but a user would also know that there are different types of lawyers and they could add them. Some main categories stand on their own and don't require sub-categories.

D. Sub-Category

User can create a sub-category. This sub-category further defines the main category in order to give the amount of detail required for users to find exactly what they want. For example, Personal Care could be a main category. Within this main category, a user could create: barbershop, hair salon, etc. For the main category of lawyer, you could have a patent, criminal, or immigration lawyer. These sub-categories are created by the users and are added to the overall system. Users would also see an increase in their title by the participation in adding to the site.

E. Reviews and Rankings

Reviews and Rankings are vital to the “experience” that the system is presenting to the user. By implementing a very detailed review and ranking process, the system enables the user to obtain valuable information. The objective of the reviews and rankings are to give each user a detailed understanding of the listing and showcase why they have received such a favorable review.

Other local business review websites are already populated with listings of local and nationwide businesses. The difference compared to this present invention is that the system starts with no listings. Every listing that is added within each main and sub-category is created first by a user that has had a positive experience that they feel someone else could benefit.

In a number of local review websites, the result of search on “lawyer” might return a result of 200 or more lawyers in the local area. But out of those 200 lawyers, maybe a user has rated between 2 and 10. The rest of the listings displayed simply ask the user to be the “first to rate” the business listing. In contrast, this present invention only shows listings that have first been rated. Users will know that someone took the time to list everything that is searchable on the system. If a local review website has no listings rated, a user doesn't know what's good. If some listings are rated, but some are not, a user doesn't know if they might be better than what is already rated by other users. A user would have to hope that of the listings that have been rated, that they are not missing the best of the group, simply because no one has ranked it.

Other local review websites provide generic ranking systems. For example, it is very common for web directories or local review websites companies to rank a particular business “very satisfied, satisfied, unsatisfied, or good, great, etc”. This information does not get to the detail required for a user to narrow down the choices. There are no “measuring sticks” of criteria to properly evaluate the listing. For example, if there were a listing for plumber, the system would rank the plumber in areas that are relevant to what people are looking for in a good plumber (price charged, work done in a timely manner, customer service, can clearly explain the work being done, etc). These criteria to rank a business would give a possible customer a better viewpoint on “how” that person gave a particular business a ranking. This further allows a user to make a decision based on real information and more measurable criteria.

In addition to the detailed ranking that is done, the system further enhances the results it presents to the user by calculating the number of users via conventional means that have experienced this listing and the ranking that each user gives to come up with a “power ranking”. The system displays all listings by “power ranking”. This presentation of the listing is designed to present to user “the best of the best” listing and the “best of the rest”. By separating the presentation on the web page this reduces the amount of time a user spends looking for the good listings. The partitioning of the web page into the “Best of the Best” and “Best of the Rest” is further explained later in this document.

2. Topics of Interest

The system is divided by topics of interest within each city and state. Once a user is within the city of choice, they are able to select a topic of interest. Once in that topic, the user can select the category (or recommend a category) and listing (or recommend a listing) that they desire information about.

The following default topics of interest are created for each city. New topics are determined by the users.

Services: The services tab showcases primarily business listings. Located in this tab are recommendations that users give for service-orientated listings (lawyers, plumbers, building contractors, etc). The services topic represents primarily the same type of listings that you can find in the traditional “yellow pages”. There would be a “host” of services in a particular city whose role would be to showcase the top rated (by the users) services and also showcase their own twist on services in their local area.

Products: The products tab showcase products what users can buy. These are recommendations that users give based on their experiences with products (cell phones, TVs, skin care, clothes, etc). There would be a “host” of products in a particular city whose role would be to showcase the top rated (by the users) products and also showcase their own twist on products in their local or nationwide area.

Entertainment: The entertainment tab showcase things to do in their local area. These are recommendations that users give based on their experiences in their local area (restaurants, museums, nightclubs, sporting events, etc). There would be a “host” of entertainment in a particular city whose role would be to showcase the top rated (by the users) entertainment spots and also showcase their own twist on entertainment in their local area.

College Life The college life tab showcases what's happening on college campus. Since many colleges are a city within itself, with its own identity and culture, the users would give recommendations to other students on what's good on campus (best teachers to take, best spot to buy books, best extra-curricular class to take, best fraternity, best sorority, best club to join, best place to get something cheap and good to eat, etc). There would be a “host” of college life at that particular school whose role would be to showcase the top rated (by the users) things on campus and also showcase their own twist on college life in their local area.

Travel: The travel tab showcases where users have gone and what they have experienced. This tab groups listings based specific interest (Mature Crowd Hotspot, College Crowd hotspot, Best Romantic Destination, and local destinations and things to see in your area). There will also be a “host” who will visit the local spots in the local area as well as encourage users to a “remote” host if they travel internationally. Eventually, the present invention will allow for international hosts in cities around the world in which these “hosts” can be “on location” in the city they live instead of relying on US travelers. By defining the interest, users can quickly find not only what destinations they want to travel to worldwide, but also what they can find right in their backyard with local recommendations.

TBD: To Be Determined. This tab allows for users to submit what subjects they would like to shown on the site. Maybe there is a subject that isn't covered, or maybe a subject needs to be removed from an existing topic of interest and should stand on its own. Users can vote for what they think should be shown on the site and once a pre-defined period is over, the main video host will announce the launching of the new topic of interest. This topic, like all the others, will be shared with all the cities.

3. Main Categories

Main categories are listed underneath each topic of interest. These main categories are designed to guide the user to where they would look to find the information that they need or to create the listing that they would like add within the main category. For example, when the user selects the “travel” topic of interest, they will see worldwide travel recommendations and local travel recommendations. The user has the option to select one of the categories and either read about what other users have already recommended and rated, or create a new main category of their own that hasn't been thought of by any user. Such main categories could be: most romantic hotspot, college-crowd hotspot, mature-crowd hotspot, etc.

4. Sub-Categories

Some main categories do not cover the amount of detail needed to provide the user with the information needed to make a decision for what they are looking for. When this is the case, further sub-categories are created. These sub-categories further describe the previous main category and could even “drill deeper” within the main category one or two levels depending on the subject matter. For example, under the “college life” tab, a user might want some information on what professors to take for a certain class. In this example, the user would click on the category “Best Professors”, which would load a second page that would list the possible subjects that professors could teach. Of course, if a particular subject to take in school isn't listed in the default sub-categories, the user could “add” a new subject and subsequently add a listing within this subject. There are some subjects taught in school that are common among all schools, but there are some subjects that are specific to a particular school. For example, a school could have a main category (under Best Professors) of “Business”, but then once a user clicks on business there may not be a subject for that school called Economics 101. That user, knowing that Economics 101 is taught at their university could add this particular subject and add the teacher's name that they feel is the best teacher to take for Economics 101.

5. Geography

The site is divided into city and state. The site begins with a baseline of cities and with all states. As users access the site and would like to add new cities, they can add new geographic cities and “get credit” for adding the content. The users name will be attached to the city to further give credit to this user for adding content to the site.

6. Video Hosts

To enhance the user experience and to provide greater insight into products, services, etc that are being offered, people will serve as video hosts for their respective city/school. These video hosts operate in similar fashion to television hosts of traditional TV programming. For example, TV hosts lend their personality to a TV show to “bring to life” the show to viewers. TV hosts are entertaining and help guide and enhance the delivery of the desired content to viewers. The present invention's “internet” video hosts provide a similar function to the website. As users add content and they rank their preferences, these video hosts highlight what the users have recommended as well as add their own unique point of view. They can create programming to highlight the top choices by users, or they can create unique shows based on the topic of interest they are covering. “The TOP SPOT”, showcases the #1 listing as voted on by the users. “Up and Coming”, showcases newly released products, businesses, etc that have recently started and users haven't had a lot of time to properly review yet. “What's Hot In”, showcases the listings that are in the Best of the Best.

A. Explaining the Site/Tutorials

These hosts also help explain to other users on how to understand and get the most out of the website. By being the “guide” for the users in their respective city/college, these hosts will help explain the features of the site, what to click on, what different things mean on the web pages, how to find things in their city/college, how to increase their “title” within the site, and anything else that helps a user use the present invention.

B. Main Host

The main host will service as the premier host of the site. This host will create the initial content that is displayed when new cities are created. This main host will create some of the tutorials that will be used to help explain to both users and business owners how to get the most out of the present invention. If there are exclusive interviews or popular red carpet affairs (just like traditional TV hosts), this main host could be in attendance along with that respective city/college host to be “on location” and cover the event. There could also be co-main hosts as determined by users and company management.

C. City Host

Each city will have its own host or hosts. If the user is viewing the content from the city of Miami, they would be greeted on the Miami homepage by the main host or hosts of Miami. The user could select the “travel” topic of interest and have a separate host for Miami that specifically deals with travel recommendations in Miami that user's have submitted. Video hosts use content that is user-driven to get ideas on what can be created for additional video programming. Users will have the ability to see the video hosts and be able to view their past episodes and current videos that may have been uploaded for viewing. Users will be able to rate these videos so that through the city homepage, users can see top rated hosts in all cities and can view the most popular hosts and in what city they are from. This capability gives users the ability to easily see different programming from different hosts.

D. College Hosts

Each college will also have their own host or co-hosts. These people will be “on-location” at different events on the college campus. These hosts will showcase college life and show other students at that college where all the “good things” are happening. They will highlight the categories that are rated by the students. Some of the content that these hosts can create are based on the feedback that users give by rating things on campus, while other video programming is created based on what that particular college hosts feels is popular and is widely recognized on campus.

E. Video Programming Example

Each video host will create unique programming based on their individual section of the website. For example, you will have a host under the main topic of interest called “College Life”. When a user creates a college, there will be an opportunity for someone to be the host of that particular college. This person's job would be to be “on location” at their respective school to give their personal insight into the things that the college students themselves recommended. If a category were: “best place to buy books”, that person would “report” about the best places that users have recommended and interview people at the bookstore getting their opinions. Another category could be the “best place for cheap eats”, that host could be on location at a particular establishment interviewing with the restaurant owner and giving good tips and information that would help other students. If the main category was “best sorority”, that college video host could interview the sorority that was voted one of the best on campus, and actually take the time to interview the leaders of that sorority to find out what makes them the best. That host could also attend a sorority function to give a first hand portrayal of “why” this is considered one of the best sororities on campus. This video programming would be done in the same way as a traditional television person would “host” a television program highlighting a sorority and why it's considered one of the best. The same creativity used to “cover the story” by news reporters, television hosts, etc, would be used to create video programming based on input by the users. The “hosts” are encouraged to use their creativity for their programming.

F. Users Rating Hosts

The site is designed to encourage a host for each city/college that is created by users. When a new city is created, the system will create a section by default for people to submit their videos to become the video host for New York, Miami, Washington D.C., Pittsburgh, Dallas, and any other city in the US and even around the world. The main video host will help guide prospective hosts to understand the process of submitting their videos for consideration. Each video host will create programming unique to their own geographic or subject matter. Users can rate all of the videos created. The purpose of this rating is for users to give their opinion on how valuable these videos are, how entertaining, and how relevant they are to understanding the listings that are on the website.

7. Advertiser

An advertiser is any individual or organization that provides a sponsored listing to the system. Any person authorized and affiliated with the advertiser can initiate the placement of ads on pages corresponding to appropriate category, topic and geographic location. For example, a business might have a sales and marketing staff whose job is to procure advertising space for its business. Those individuals could call the system owners and express desires to advertise on the system. Advertisers also have the ability to update and edit their advertisement through both automated and manual ways. Businesses that pay for an enhanced listing can edit the content. Once an advertiser pays to enhance their listing, that listing is locked from any more edits by outside users.

Advertisers can call the systems administration service to issue changes or updates to their sponsored advertisement. An advertiser does not necessarily need to be a business to be an advertiser. It can represent any entity that wants to express some sort of message to the end-users of the system via video or text. Many subjects are represented by the system and as such advertising can come in many forms. Entities that seek advertising do not have to be “for-profit” in nature. Advertisers pay a fee to have their sponsored listing and spotlight national and local videos appear next to the user created listings. Advertisements can be by in text form, graphic, or video form. These videos can appear with the listings, stand alone using the “spotlight” placement on the page, or can even appear within the video programming created by the video hosts in different cities/colleges similar to how commercials run on television programming.

A. Fee

Advertisers will pay a fee for improvements to their listings and advertising on the system. These fees will either be charged through a fixed price contract or a per-click system. Advertisers can choose what they would like to enhance from their listing to increase the likelihood of sales.

B. Enhanced Listing

A free, basic listing that can be uploaded by a user could contain: name, address, and phone number. These basic listings are free of charge. If a listing is about a particular person or business, that entity could have the option of paying for an enhanced listing. Enhanced listings are a fee-based program that enables business owners or content owners to enhance prospective users experience with the listing. The options available include, but are not limited to: a business profile, website link, 30 second commercial, video advice columns/workshops.

Business profiles can contain information relevant to the operation of a particular business. Data such as operating hours, forms of payment accepted, overview of what the business/listing does, and pricing information can be included. Web site linking can be added to allow users to connect directly to a particular listings website. The business or content owner can also upload a commercial of that business to also be used via a video player to show the customer further what is being offered or sold. This capability is the same as advertisers have via traditional television, but in this case it is brought to the user via the internet. Any listing for any topic, not just business listings can be enhanced depending on the subject matter.

C. Sponsorship Links

Advertisers can also showcase their products or services by paying a fee to create a sponsored listing. These listings are displayed in a different section on the web page from the normal user-created listings. The placement of these sponsorship links will vary. In the beginning, the present invention will allow placement of ads on a first come first serve basis on the actual web page. For a monthly fee, the links will have an unlimited click-through charge to the advertisers business or information. With further developments planned, the system will incorporate a mixture of a monthly fixed fee, a per-click fee, and bid-priority placement. The bid-priority placement allows business to bid to see which sponsorship link is placed on the web page and how often.

D. Advertiser/Listing Interface

If a particular business owner or content owner decides to pay for an enhanced listing, that advertiser has full control over the listing. The system will provide the content owner an interface to remotely edit their listing and content. Advertisers can also upon payment of fees, upload other relevant information. Varying levels of technology will be used to interact with the system to include: desktops, laptops, mainframes, PDAs, or any other computer system that allows for web services and connectivity to the present invention. Traditional “hardcopy” information can also be faxed to administrators to take requests for updates and changes.

E. Video Spotlight (National and Local)

Advertisers to showcase their product or service to the online community can use the video spotlight feature. These video spotlight ads are placed on the web page in a section of the page separate from the user-generated listings, but are relevant to the content displayed. These video ads can be used on the website with the same spirit that a regular commercial on television would be presented. These videos can be created to run as soon as a web page is loaded into the browser or once a user clicks on the video icon. These videos will appear in a manner that does not interfere with the normal content of the page, but has a distinct placement on the page to highlight the content being shown. Users can increase the size of the video if desired, or can simply watch the video play while continuing to view user recommended listings through the main portion of the page. These video spotlights will be primarily on the city/college homepages, but can also be used throughout the system on different web pages. These video ads will give prime placement for advertisers to target specific users.

F. Banner Ads

Banner ads will also be used within city/college homepages and throughout the website to allow advertisers to target their ad campaigns.

### 8. Information Technology Infrastructure

A. Servers

A server is any machine within the overall system that takes requests from users and then funnels those requests to either middleware or back-end services to achieve a desired result. These could be, but not limited to: web servers, mail servers, and video servers. Much of the presentation layer to the user resides on the web server and video server.

B. Instructions

Instructions serve as the middleware between the server and the database cluster. These instructions can be anything that allows the system to perform some sort of function for the user. Software developers and web designers can all contribute towards these instructions using software. This software can be designed “in-house” or can be purchased. Any number of programming languages could be used such as: PERL, C+, C++, JAVA, Python, PHP, etc.

C. Algorithm

The preferred embodiment of the system will determine placement of listings (Power Rank) and the subsequent placement in either the “Best of the Best” or the “Best of the Rest”. This will utilize the following sets of data:
Number of people rating the listing—The number of people who rate the listing will be factored into the system for determining placement of the listings. The increasing number of people will increase the weight that is used in determining which listing is the best.
Criteria Scores—The individual criteria scores will be used to factor the placement. For example, criteria such as price, customer service, timely repair, bedside manner, music in the club, etc will receive a particular score. The system will account for the sum of the scores depending on the weight of each criterion. The sum of the weighted scores will also factor into the determination of the placement.
Agree or Disagree—A simple vote via the web browser that a user can submit for a listing one time to either agree with a placement of a listing or disagree. Every time there is a submission, this effects the overall power rank of that listing in either a positive or negative total. The total number of submissions also provides a weight into the overall power rank.
Price criteria—A certain weight will be taken into the overall score for listings that have price as one of their criteria. Making a final selection doesn't always come down to price, but anything that is well received and has a good price will have a heavier weight than those listings that don't.

D. Database Cluster

The database will hold all of the data of the system. The database cluster will be optimized in order to fulfill inputs and requests from users. The database cluster serves as the back-end of the system.

E. Program Interface

The program interface is any application that is used to allow the user to interact with the system. The majority of users will utilize a web browser to connect to the web in order to input or receive data from the system. Although the web browser could be the system of choice for a number of users, any hardware or software that allows internet connectivity can be used to connect to the system.

F. User Access Device

The user access device is any physical device that allows a user to run an application to connect to the internet, and subsequently to the system. A user could typically use a desktop computer or laptop, but other devices could include: PDA, cell phone, TV, etc.

G. User

The user is the person that is interacting with the system. The user will utilize some means of connecting to the internet to connect to the website.

### 9. Request Attributes

The request is an inquiry to the system based on specific criteria set by the user. The user will define the request information using combinations of geography, topic of interest, main category, or sub-category. When a request is sent to the system, the system will query the database cluster and present information to the user utilizing the combinations of geography, topic, main category, or sub-category.

A. Geography Request Attributes

Users can request information that is focused on geography. The system is built with users able to not only search on existing geography listings, but the user can also add geography to the site in order to expand the number to cities available. Examples of geography that can be defined are: street address, city, state, zip code, county, and neighborhood. The system is designed to allow users to search for listings based on this geographic information. Users can further refine their searches by using geography to focus on a particular listing. By using an editable search box or by clicking the geographic location desired, a user is able to further refine the information requested.

B. Category Request Attributes

The system is built with default categories designed in order to help guide the user into what is currently on the system. Built with a hierarchal category structure, the system is designed to allow users to “tunnel” further down a category to find the specific category of interest. The site is purposely designed to be lacking in categories to allow the user to see the need to add categories and sub-categories (and the subsequent listings). For example, in the “Entertainment” topic of interest, if a user wanted to know about “nightclubs”, the user could select this category and then “tunnel” further into a variety of sub-categories. Some sub-categories that could be listed by default could be hip hop or rock nightclubs. The user could then proceed to either submit listings based on categories that are already present, or add a category of their choosing such as “top 40”, “house”, etc. In the topic of interest “College Life”, the user could see the topic of “Best Professors”. By clicking on this category, the user could see the default listings (Math, English, etc) and if desired, enter teachers they recommend for those subjects, or create categories that aren't listed. The system is designed to list a small amount of default categories, while allowing the users themselves to continue to add to the existing categories. This creates a since of ownership in the website for everything added. The user receives credit, not just in the continued increase of their title, but shown on the web page itself next to their submission.

### 10. Requests and Response Format

The request can deal with various inquires selected by the user. The user can be looking for a specific listing (determined by category or geography), video host programming (based on category or geography), or query searches based on search terms by category or geography. The user can either navigate the site by selecting a state and further refining location by city/college as desired. Users will input search terms and geographic location to obtain listings.

The objective of the site is to present listings that are “good” listings. In the case of business listings, the goal is not to make all listings available in a particular geographic area viewable, but rather what really is good, based on real user experience. The listings are organized on the page based on the power rank it received. By organizing the listings into two groups, those that are specifically looking for the top rated can quickly see which listings have received the most positive feedback from the community. This grouping also allows a user to view listings that are not in this top group, but in his/her mind deserve to be. This is when a user can submit their reviews in order for that listing (in the lower section of the web page—Best of the Rest) to climb into the next bracket. Each listing will be in two sections on the web page, these are: “Best of the Best”, or “Best of the Rest”.

A. Best of the Best

All listing can receive a score of 1-5. All listings that receive a score of a “3” or higher are listed in the “Best of the Best. This will allow users to view the best listings available first as listings appear on the page. This represents the best that has been recommended and is an easy way for a user to see the listings that have had both the most response and the most favorable reviews.

B. Best of the Rest

Listings with scores 2 or lower are placed in the “Best of the Rest” area. If a user sees a listing in Best of the Rest, they can either “agree” or “disagree” with the placement of that listing. If a user disagrees, that adds “positive weight” that will further enhance a listings power score total. With enough positive reviews and “agree” submissions, a listing can climb from the “Best of the Rest” to “Best of the Best” section. Listings in this section of the page are limited in the content of what is displayed to the user. The summary of the criteria that was graded and the power score received will be displayed. The only thing that will not be displayed will be the comments submitted by the users of that listing. A listing that is in the “Best of the Rest” section is a result of being graded “poor” by the users of the site. Because the spirit of the website is not to degrade or put down a particular business or listing, the site will not display any comments.

“Best of the Rest” listings don't display all that the users submit. Since the focus of the present invention is to showcase and present “good” listings, the system will temporarily hide all comments for listings that appear in the “Best of the Rest” category. The reasoning is because for a listing to appear in this category (power score 2 and below) means that there isn't a lot of good things to say about this particular listing. If the listing was really good, then it wouldn't be in this section of the web page. Instead of focusing on the negative and displaying possible very negative comments, the system will mask them until this listing possibly makes it to the “Best of the Best” section. If a listing has achieved “Best of the Best” distinction, then all the negative comments are far outweighed by the positive and therefore really don't carry as much weight and do not further drag down a particular listing. A listing in the “Best of the Best” examines the entire body of work for a listing. It is understood you can't please everyone, and listings in the “Best of the Best” are no exception because listings in this section will have both good and bad comments. But these listings are showing users that the listing is good “overall” not 100% of the time. A listing can always change sections, and a marginal listing can always move into the “good” section. The low ranking, plus the placement in the “Best of the Rest” most likely means that the business will not get much interest from members until it gets a more favorable ranking. Each video host will inform users of how to let their voice be heard and support listings that they feel should be higher.

Every listing can rise to the “Best of the Best” by increasing the number of users that comment about the listing as well as the cumulative score of all those criteria. For every listing a user can either click the button to enter their own review or select “agree or disagree” to quickly give their input of a listing. By taking into account the same various factors to grade a listing, a particular business for example could climb up the ranks and enter into the “Best of the Best.”

### 11. Fees

A. Sponsored Text Listings

Each advertiser is allowed to pay for placement of text-based ads by a fixed fee amount. The present invention will also implement in future software releases a feature that has a bid process based on the amount each advertiser is willing to pay for priority placement on the web page. These “Sponsored Listings” are placed on the web page in an area that is separate from user content. Each sponsored listing will be noticeably different from active listings so users will know the difference between the two. Fixed fees will constantly be re-evaluated to determine relevancy in the marketplace based on the present invention's profitability and success with users.

B. Banner Ads

Banner ads are graphical images of the site that advertisers pay for. These ads can link users to external sites that users can navigate separately from the current system. Fixed fees will constantly be re-evaluated to determine relevancy in the marketplace based on the websites success and profitability.

C. Video Ads within Host's Programming

Each video host will be given the opportunity to showcase services, entertainment, and other topics of interest in their respective cities/college. Based on the category and the programming being offered by the hosts, advertisers have the option of paying to add video ads to the programming created by these hosts. These 30-second spots can be shown between or after the host-created programming segment. Fifteen-second video ads can also be placed prior to beginning of a video host's show. These 15-second video ads will be relevant to the subject that the video host is going to showcase in their show.

D. Spotlight Videos (National and Local Video Spotlight)

Spotlight videos are video ads that are paid by advertisers to be shown on pages throughout the site. The placement of these ads can be determined by geography, category or subject matter of the listing. These videos can vary in length depending on the page where the video spotlight is shown. Either one or multiple video spotlights can be placed on a web page. The placement of these miniature “TV's” on the web page will not interfere with the current content displayed on the page. This placement on the web page will provide advertisers another avenue to market their products and services with relevant listings. By allowing spotlight videos to be placed next to listings of the same subject matter, the advertisers can target the right audience.

E. Determining Fees

All are fixed fees, with flexibility to bid, and other fee structures.

### 12. Category and Geography Listings

A. Listings Grouped by Category

Listings are grouped by category. You will have the main topic of interest called “College Life.” Within “College Life” users will be able to add their college. As the number of college's increase, users have the choice of adding additional categories of which to submit listings. For example, within the University of Southern California, you will have the main default categories such as: Top Professors, Best Place to Buy Books, Best Fraternity, Best Place to Eat, etc. These would all be categories that would hold listings in and around the college campus. Under the main topic of interest called “Services”, you could have a number of different categories: lawyers, doctors, auto repair, etc.

B. Sub-Categories Refine Main/Default Categories

The main category a user selects will determine if a user can “drill down” a category. For example, in the category of “home repair”, you could have: drywall, decks, plumbing, etc. These sub-categories created by users allow another user to find what they might be looking for.

C. Geography Deciding which Categories are Shown

Users add both cities and listings. When a city is created, a number of default categories will already be shown to allow the user to understand how categories are created. All categories are matched up with a particular city. When selecting a city to search, a user will access all listings created by users for that particular city. User can further search in a more broad way by searching by state. By selecting query terms, a user can conduct searches by category, city, or state.

### 13. Listings

There a number of sections that can be added for a listing. Depending on the subject of the listing the following could be included:

A. Address and Phone—If a particular listing has a phone number associated with it then a user could enter a phone number and address. This basic information about a listing is free of charge and cost nothing to post.
B. Criteria to be ranked—Each listing will receive a “power rank” based on a number of different criteria. For example, an accountant office could be ranked according to: A) good service B) Explaining tax law C) Ease in making an appointment D) satisfied with the result. These criteria allow a user to get a better idea of how a listing is graded instead of the way some local review websites. These review websites will simply create criteria such as “good”, “bad”, “excellent”, or give it a number of star rating. Under the College Life topic of interest, you could rank the category of “Best Professors”. Users can create subjects to rank professors. For example users could input “Freshman Chemistry” and enter the best professor to take for Freshman Chemistry. Under this category, professors could be ranked according to A) ability to teach the subject B) availability after class for help C) difficulty of tests/assignments, etc. The goal of the ranking system is to give users a more complete picture of this listing and “what's good” about it.
C. Pictures—With each listing, users can also upload photos pertaining to a particular listing. These pictures allow the user to input information that they personally experienced. This feature is also free, but with limitations depending on size and number of files.
D. Add Website—Each listing can also have a website link that is affiliated with the particular listing. This website link will allow users of the system to go directly to the website in a secondary browser. This feature is free, but with limitations based on the number of links for websites.
E. Company Description—If a particular listing is a business, a business can input a company description. This section is for business owners only and is restricted to business owners that pay for the enhanced listing.
F. Commercial—One of the focuses of the present invention is to help small businesses achieve success. The business model that the system follows provides tools for small business owners to get started and achieve the word of mouth that is required for them to obtain a foothold in the marketplace. This fee-based feature allows any business, especially small businesses, to create and show a user generated or professional 30-second commercial to advertise their business. This feature allows prospective users to obtain even more information concerning what a business has to offer. A commercial is not limited to just businesses. Any listing that can be created can also have a commercial depending on the listing. Depending on the subject, which is created by the user, there could be any number of listings that could possibly carry a commercial segment. No matter how big or small a business, this provides a low cost option to further market themselves to the community.
E. Free Advice Tips/Video Workshops—Another feature specific to the small business owner is the fee-based “free advice tips/workshop”. The video feature allows a business owner to further promote their business by giving helpful tips in their profession to prospective users via user-generated video. This free advice video feature has a number of benefits. One, it allows the business owner to get the word out on the service that they offer by giving helpful information that a user could use. Two, a user benefits by watching this informational video and gets more familiar with a particular industry. Three, by watching these videos, businesses get to become more “personal” to the user and the user can “feel” the sincerity, and overall feeling that they might get from the person on the video. A real estate professional could give real estate tips that could help a user find a new house. A landscape business could give tips on landscaping and how to use plants and materials. A hair salon could give beauty tips and how to take care of your hair. This is a tremendous marketing tool that a small business can master to obtain more customers and increased word of mouth. A useful and popular video tip can increase word of mouth and create a since of trust. The free advice workshop is not limited to just businesses. Any listing that can be created can also have advice column/tips. Depending on the subject, which is created by the user, there could be any number of listings that could possibly carry an advice tips segment.

### 14. Reviews

Reviews are an essential part of the website. Every user can rate a particular aspect of the system. Users can rate a number of features within the site.

A. Listings Reviewed

Users create listings. Each listing will have different criteria to rate. Depending on the listing, there are normally at least 4 criteria to rate a listing. For example, if you had a listing under the “travel” main topic of interest called the “most romantic hotspot”, the following criteria could uniquely be used to describe it: easy on the wallet, able to get sleep at night, activities to do, incredible sights. This more defined criteria will allow the listing to give more information to the user than just the generic “good, great, excellent” or the “standard 1-5 star rating”. By giving the user a “unique” criteria to rate instead of something generic, the user will benefit and have a better idea of exactly what makes this listing a good recommendation. Business listings, product listings, and college recommendation listings can all have their unique criteria and be totally different from each other.

Each criteria rated will feed the overall power rank score that will determine a listings placement on the web page. The higher the power rank score, the higher the placement of the listing when viewed by the user.

For example, if a user was ranking a nightclub, the user could give individual rankings on the criteria of 1) type of crowd 2) selection of music 3) cost of drinks 4) enough of the opposite sex. By allowing each user to give a more exact way of ranking a nightclub based on “what's important”, then a user is able to more effectively make a decision on whether or not they want to go to this particular nightclub. This decision will be based on what they view as important. If the cost of drinks is more important than selection of music, then a person could weigh these individual factors instead of some generic rating like most local review websites.

B. User Reviews

There will be listings that users can also give their comments concerning a particular listing (whether it was helpful, etc) that factored into the scores that were given. If a user's comments were of value to another user, that user could recognize that review based on whether or not that it helped them. This “user feedback” also assists other users in seeing how relevant a particular users “contribution” has been to the site.
30 sec spot commercials and “Helpful Tips” videos ratings:

Because there could be hundreds of listings, users will have a chance to rate whether a particular commercial was good or whether a particular helpful tip was useful to a user. There will be sections on the site (city/college homepages) for users to see the top rated 30-second spots in a particular geographic area as well as the top rated “Helpful Tips/Workshops”. This will allow those businesses to further increase their exposure to other users. Users will get the benefit of quickly seeing the top rated videos in their area and will help them decide which businesses are good ones, and which are reputable. Business owners can “put a face” behind a general listing and further draw customers to their respective business. By having videos in which users and rate the content and also see the owners and the businesses, it will allow that user to get more trust in the business.
Video hosts and programming

On each state and city homepage there will be sections on the page to highlight the top video hosts based in the city/college. Users can rate each particular host as well as separately each of host's video episodes that they create. By calculating these scores that are given for each host, the system will be able to calculate the most popular hosts based on their reviews. The results of this calculation will be displayed on the each cities/colleges homepage. This display of popular hosts will further give prospective users a way for them to see who are the most informative and entertaining video hosts. Each host will highlight different topics of interest of the site they are assigned to. For example if there is a video host of Washington D.C., that host could also be the host of “College Life”, or “Entertainment” topic of interest for Washington D.C. Each city will have a main host. The main host of a city can also serve as a host of one of the main topics of interest. Each host will create their own unique programming depending on whether or not they are the main host or the host of a topic of interest.

The programming that these hosts create can be as creative as they want it to be. But, each topic that they talk about ties into the topics of interest that they cover as well as the users feedback that is submitted via the listings. By combining what users are talking about in addition to their own twist of what is “good”, the video host can create programming that is both entertaining as well as informative. Users can rate each segment that a video host creates. The system will create areas on each city homepage to highlight the most popular video programming that is created in both the state and throughout the US. This concept can also used internationally since there are cities all over the world that can be represented. Initially it is the goal to start in the US, but launch the business and make it available all around the world.

III. Invention Diagram

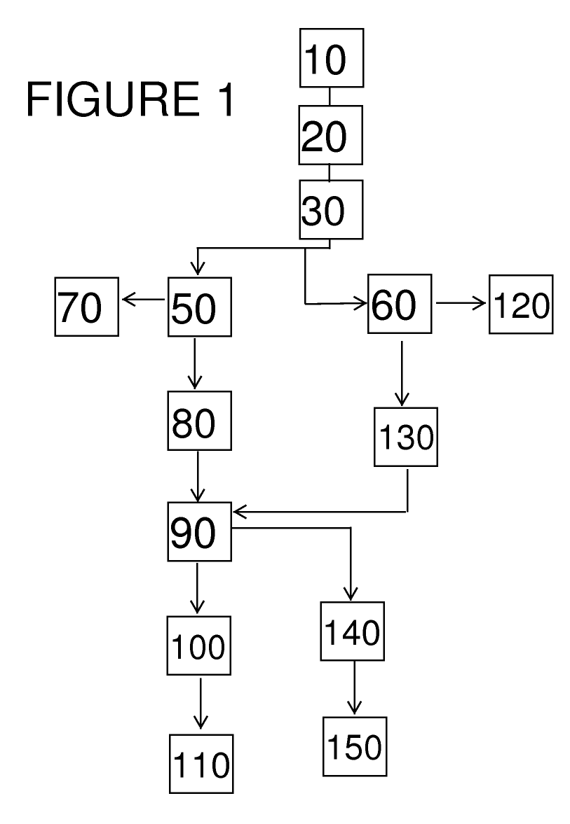

FIG. 1 is a flow chart that further depicts the preferred embodiment of the present invention in terms of the process a user might experience while engaging in the system. While FIG. 1 displays an embodiment of how the present invention may operate, it is understood that the above sections provide more direct and honed details relating to the depiction of FIG. 1.

The first step in the process relating to the present invention is for the user to gain access (10) to the system. At that point, the user will be confronted with a scenario generally inquiring as to whether or not a city/college is listed (20). This will of course be a yes (40) or no (30) situation. If no (30), then the present invention takes the user into the user created content aspect as described above. In the preferred embodiment of FIG. 1, this user created content aspect will relate to either create city (50) or create college (60) depending on the circumstances involving the user.

If the user elects to create city (50), then her or she will have the option to search a backend database (70). Otherwise, the user will engage in topics of interest (80). This relates to creating such items as services and travel. From there, the main host asks users to submit videos (90) to be hosted at the city. This submit videos (90) aspect is very important to the present invention as the videos make the system much more personal and educational on an entirely new level. Meanwhile, listings can be added to created categories (100). Businesses/owners also can create user-generated video to the listings (110). The submit videos (90) aspect also leads to a host selection (140) where hosts can then add user-generated content (150).

However, say the user did not opt to create city (50), but rather followed the prompts to create college (60). As with the create city (50) aspect, the user also may search a backend database (120) relating to the college. But once the user selects create college (60), he or she will be prompted with default categories created for campus life (130). At that point, FIG. 1 depicts the preferred embodiment where the main host asks users to submit videos (90) to be hosted at the college. Further options, as seen in FIG. 1, then revert to similar options relating to the create city (50) aspect.

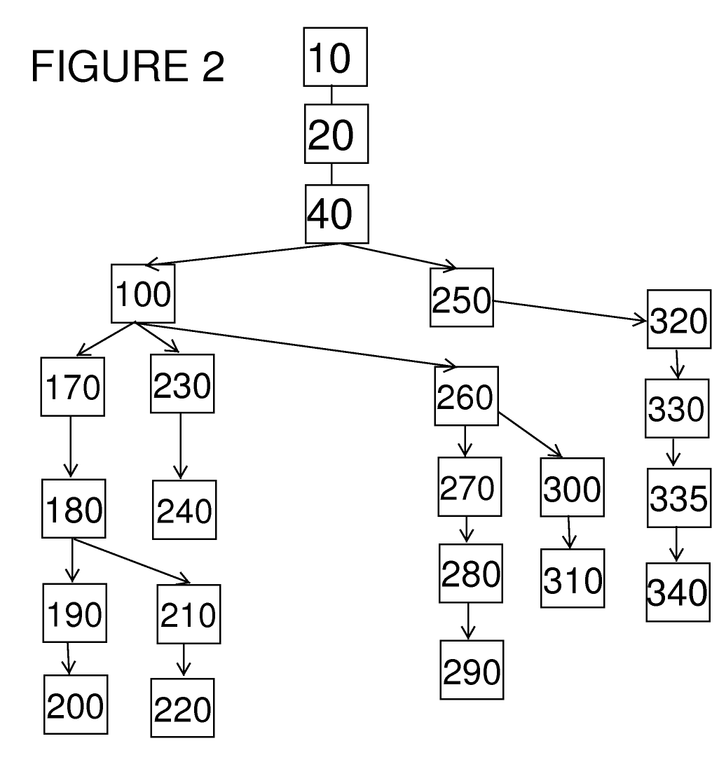

FIG. 2 relates to the inquiry as to whether the city/college is listed (20). If the answer is yes (40), then the user has additional options. The user can view listings in city/college (100). Business owners may then elect to get involved (170) where they can pay a fee (180). This permits the business owners to create educational workshops or offer tips (190) where they may then create and post video (200). Other fee (180) related items include supporting video ads (210), which also leads to the business owner creating and posting video (220).

For non-business owners, the user who views listings in city/college (100) also will have the option to rate listings and add comments (230). In addition, the user will be able to add ratings comments (240) as well. It also should be noted that additional options could occur when a user views listings in city/college (100). As FIG. 2 demonstrates, a user may add a listing (260) or add a business (270). If the user adds a listing (260), he or she may be prompted with the subject (300) of that listing and then submit category for approval (310). If the user opts to add a business (270), he or she will select business for backend database (280) and add to the site for others to see (290).

For the user who decides to view video (250) as opposed to view listings in city/college (100), the user will be confronted with additional options. For example, the user will be posed with the option to be the host of city/college (320). The user also may submit video for approval (330). If approval is granted (335), the user may create video programming based on user recommendations (340).

An additional embodiment of the present invention relates to allowing the user to query the database of a particular category in order to find “like-minded” users that also might be using the same category. This requires the entering of criteria based on individual preferences, hereinafter termed interchangeable with individual taste. This embodiment operates in much the same way as the additional aspects of the present invention described above. For example, a user might be a married, mother of five kids, who is on a strict budget. By clicking on All-American Restaurant, a user will be able to see all of the restaurants in a particular location and see this list in the order of popularity. Although this is extremely helpful, it would also be useful for this user to know what All-American restaurants in a particular location where visited by people “just like her.”

A user could query the database of restaurants within a particular location and filter the result set based on the number of users “just like her” that selected particular all-American restaurants. If a user “just like her” didn't select a particular restaurant then that all-American restaurant would not show in her results. The display would list the restaurants and how many users “just like her” also rated this particular restaurant. The system will show the restaurants in order from the highest to the lowest rated.

Essentially, this embodiment permits users to register for the site and, after prompting, enter in their “tastes,” also referred to as individual preferences Again, this aspect, like those above, operates via conventional technical means and within the similar confines of the above description. For example, a user would register onto a Web site and be prompted to enter in such information as marital status (married/single/divorced/in the hunt/not even looking), number and ages of children (0/1/2/3/4/“basketball team”), restaurant tastes (we have food at home!/looking for reasonable prices/spend it . . . if its worth it/5-star all the way), clothing (what do you mean its out of style!/chasing the blue light special/looking for sales/spend it . . . if its worth it/name brand all the way), cars (gets me from point a to b/looking for value/I'll spend a little more for something I want/nice, reliable, slightly expensive/high-end luxury), travel (what's a passport?/road trip anyone?/occasional trip in or out of U.S./I go somewhere every year at least/where haven't I been?), spending habits, electronics, social circle, club scene, etc. The user would enter this information when looking for something specific such as a restaurant. This criteria is based on what he or she is looking for. This becomes the taste aspect. The result is that the user will find out how many items such as restaurants are compatible with his or her tastes. The system of the present invention also will present these items by most popular based on the above description and function of the present invention. This also allows advertisers to focus their advertising on a particular group that matches a particular business. This gives a business a “sneak peak” into the spending habits and personality of the users of the system.

When a user registers on the system of the present invention, he or she is prompted to create a profile and select these “tastes.” This allows the user to create criteria that they can use at a later time to search for categories they are interested in. The important difference with this and other searches that take place on other local review websites is that the query that is run allows a user to find and select things they think are “good” based on what other people like themselves have already selected. Instead of seeing the highest ranked category, a user can select an additional feature within the system that allows them to see the highest ranked category based on what people that are similar to themselves have also viewed popular. The user's profile allows the system to gain valuable data that increased the likelihood that the user can make an educational decision based on what is both popular with the masses and if desired, a separate demographic similar to them.

The foregoing descriptions are not limited to the sole embodiment(s) described, but are within the scope of the following claims.

I claim:

1. A review system, comprising:
collecting user-generated reviews on a Web site;
calculating the most popular of the user-generated reviews; and
providing a video segment, produced by the Web site, for the best of the user-generated reviews.

2. The review system of claim 1, wherein said providing a video segment, produced by the Web site, for the best of the user-generated reviews is created by a local individual selected by the Web site.

3. The review system of claim 2, wherein said calculating the most popular of the user-generated reviews is determined by factoring the total number of reviews received and the number of users who tried and liked the particular listing.

4. The review system of claim 3, wherein said number of users who tried and liked the particular listing had not previously experience said particular listing.

5. The review system of claim 2, wherein said collecting user-generated reviews on a Web site is recording posts of individual comments.

6. The review system of claim 1, wherein said providing a video segment, produced by the Web site, for the best of the user-generated reviews is video produced by an employee of the Web site.

7. The review system of claim 1, wherein said providing a video segment, produced by the Web site, for the best of the user-generated reviews is video produced by someone paid by the Web site.

8. The review system of claim 1, wherein said providing a video segment, produced by the Web site, for the best of the user-generated reviews is video produced by a reporter for the Web site.

9. A review system, comprising:
making end users a producer;
making a Web site an editor; and
making an individual a reporter.

10. The review system of claim 9, wherein said making end users a producer is collecting user-generated reviews on the Web site.

11. The review system of claim 9, wherein said making the Web site an editor is calculating the most popular of the user-generated reviews.

12. The review system of claim 9, wherein said making an individual a reporter is providing a video segment, produced by the Web site, for the best of the user-generated reviews.

13. The review system of claim 9, wherein said making end users a producer is collecting user-generated reviews on the Web site;
wherein said making the Web site an editor is calculating the most popular of the user-generated reviews; and
wherein said making an individual a reporter is providing a video segment, produced by the Web site, for the best of the user-generated reviews.

14. A review system, comprising:
collecting user-generated reviews on a Web site;
calculating the most popular of the user-generated reviews; and
providing a video segment, produced by the Web site, for the best of the user-generated reviews;
wherein said providing a video segment, produced by the Web site, for the best of the user-generated reviews is created by a local individual selected by the Web site;
making end users a producer;
making a Web site an editor;
making an individual a reporter;
wherein said calculating the most popular of the user-generated reviews is determined by factoring the total number of reviews received and the number of users who tried and liked the particular listing;
wherein said number of users who tried and liked the particular listing had not previously experience said particular listing;
wherein said collecting user-generated reviews on a Web site is recording posts of individual comments;
wherein said providing a video segment, produced by the Web site, for the best of the user-generated reviews is video produced by an employee of the Web site;
wherein said providing a video segment, produced by the Web site, for the best of the user-generated reviews is video produced by someone paid by the Web site;
wherein said providing a video segment, produced by the Web site, for the best of the user-generated reviews is video produced by a reporter for the Web site;
wherein said making end users a producer is collecting user-generated reviews on the Web site;
wherein said making the Web site an editor is calculating the most popular of the user-generated reviews; and
wherein said making an individual a reporter is providing a video segment, produced by the Web site, for the best of the user-generated reviews.

15. The review system of claim 1, further comprising entering criteria based on individual preferences of the user, causing results to be generated.

16. The review system of claim 15, further comprising listing the results by most popular.

17. A review system, comprising:
collecting user-generated reviews on a Web site;
calculating the most popular of the user-generated reviews; and
providing a video segment, produced by the Web site, for the best of the user-generated reviews;
wherein said providing a video segment, produced by the Web site, for the best of the user-generated reviews is created by a local individual selected by the Web site;
making end users a producer;
making a Web site an editor;
making an individual a reporter;
wherein said calculating the most popular of the user-generated reviews is determined by factoring the total number of reviews received and the number of users who tried and liked the particular listing;
wherein said number of users who tried and liked the particular listing had not previously experience said particular listing;
wherein said collecting user-generated reviews on a Web site is recording posts of individual comments;
wherein said providing a video segment, produced by the Web site, for the best of the user-generated reviews is video produced by an employee of the Web site;
wherein said providing a video segment, produced by the Web site, for the best of the user-generated reviews is video produced by someone paid by the Web site;
wherein said providing a video segment, produced by the Web site, for the best of the user-generated reviews is video produced by a reporter for the Web site;
wherein said making end users a producer is collecting user-generated reviews on the Web site;
wherein said making the Web site an editor is calculating the most popular of the user-generated reviews;
wherein said making an individual a reporter is providing a video segment, produced by the Web site, for the best of the user-generated reviews;
entering criteria based on individual preferences of the user, causing results to be generated; and
listing the results by most popular.

18. The review method of claim 17, further comprising displaying the user-generated reviews for listings that are average or positively ranked.
